(19) United States
(12) Patent Application Publication
(10) Pub. No.: US 2011/0306028 A1
(43) Pub. Date: Dec. 15, 2011

(54) EDUCATIONAL DECISION SUPPORT SYSTEM AND ASSOCIATED METHODS

(76) Inventor: Sarah E. Galimore, Albany, NY (US)

(21) Appl. No.: 13/159,928

(22) Filed: Jun. 14, 2011

Related U.S. Application Data
(60) Provisional application No. 61/397,680, filed on Jun. 15, 2010.

(51) Int. Cl. G09B 7/00

(52) U.S. Cl. 434/322

(57) ABSTRACT

A decision support system and method for facilitating achievement of an educational or career-related goal is provided. The system is comprised of a decision support server and at least one client device. The system facilitates decision-making with regard to education or career goals by performing data analysis between a user-provided profile and a benchmark profile, identifying variances between parameters included in the user profile and the performance metrics included in the benchmark profile, and using a rules engine to select a recommended resource, action or series of actions. The decision server may compile the recommendations into an education guide that is made available to the user and periodically updated. In another aspect, the decision support system provides automated and advisor-assisted monitoring of a user's progress. In another aspect, the system facilitates the public viewing of parameters included in user profiles.

### RELATED APPLICATIONS

The present application claims the benefit of U.S. Provisional Patent Application Ser. No. 61/397,680 titled DECISION SUPPORT SYSTEM AND METHOD, filed by the inventor of the present invention on Jun. 15, 2010, the entire contents of which are incorporated herein by reference.

### FIELD OF THE INVENTION

The present invention relates generally to decision support systems and, in particular, to a decision support system and method for facilitating achievement of an educational or career-related goal.

### BACKGROUND OF THE INVENTION

The process of transitioning to an institution of higher education, or to a new professional organization or career, can be a complex and daunting process. Students must first identify an institution or organization they would like to transition to. They must then identify gaps in their knowledge or performance that would potentially prevent them from gaining admission or being successful at the institution or organization. Upon identifying these knowledge or performance gaps, they must then select educational resources or tools and decide which are most appropriate for helping them close such knowledge or performance gaps. They must then successfully complete a selected training. However, this process of identifying an institution, job or career, and becoming qualified to transition to the chosen path continues to be a problem.

Existing solutions are fragmented, focusing on only a small portion of the overall problem, thus failing to provide a comprehensive solution. Due to their fragmented nature, such solutions are also inefficient and costly, requiring users to go to different sources for different services, each charging a different fee. Programs for providing academic planning and enrichment are often inconsistent across schools.

Some solutions seek to address this problem by providing a guidance counsel automation system. However, such systems are unable to address the full spectrum of student development and planning needs. Many solutions also target students at only the junior or senior year level and focus on the areas of college admission assistance, completing college applications, and selecting a school. However, these activities may fail to address the long-term goals of the student.

Therefore, given the limitations of existing solutions, it would thus be desirable to have a system and method for providing educational decision support to users that may wish to commence in a higher educational institution or a new career. It would further be desirable to have a system and method for monitoring and managing the performance of people making such a transition in a less fragmented and more personalized manner. Furthermore it would be desirable to have a system and method that is better able to match such persons with resources that are most suitable for helping them achieve their educational or career-related goals.

Still further, it would be desirable to have a system and method that improves the process by which students or professionals are matched with potential educational institutions, careers or jobs. It would also be desirable to have a system and method for facilitating collaboration between people having similar educational or career-related goals.

### SUMMARY OF THE INVENTION

In view of the foregoing, it is therefore an object of the present invention to provide a decision support system for facilitating achievement of an educational or career-related goal that does not suffer from the drawbacks of known solutions.

The system of the present invention advantageously provides decision support to people desiring to transition to an educational institution or a new career. The system of the present invention may advantageously monitor and manage the performance of people, making the transition to an educational institution or new career less fragmented and more personalized. Furthermore, the system of the present invention may advantageously match such persons with resources that are most suitable for helping them achieve their educational or career-related goals.

The system of the present invention may advantageously improve the process by which students or professionals are matched with potential educational institutions, careers or jabs. Additionally, the system of the present invention may advantageously facilitate collaboration between people having similar educational or career-related goals.

The educational decisions support system, according to an embodiment of the present invention, may include a decision support server. The decision support server may include a memory to store a user profile and a benchmark profile. The user profile may be defined by a set of parameters. The benchmark profile may include one or more performance metrics.

The decision support server may include a decision support module to compare one or more parameters from the set of parameters with the performance metric. The decision support server may also include a rules engine to compare the user profile with the benchmark profile. The rules engine may include rules to be used to compare the user profile and the benchmark profile. The rules engine may determine variances between the parameters and the performance metric, analyzes the variances, and recommends an action based on the variances.

The decision support system of the present invention may include a notification module that may present a notification based on the variances determined by the rules engine. The decision support system of the present invention may also include a collaboration module that compares a plurality of user profiles to determine educational goals that are substantially similar. The collaboration module may recommend a collaboration among the plurality of user profiles with educational goals that are substantially similar.

According to an embodiment of the present invention, the collaboration module may compare the plurality of user profiles to determine a group leader user profile. The group leader user profile may be included in the recommended collaboration between the user profiles.

The decisions support system of the present invention may include a user profile creation module that may prompt a user for the set of parameters to be used to generate the user profile. The decisions support system of the present invention may also include a tiered operating structure including a database tier, an application tier, and a presentation tier. The database tier may include databases. The application tier may be in communication with the database tier and may include a web application to control managing data within the databases. The presentation tier may be in communication with the application tier and the database tier, and may include a user interface to allow the user to operate the web application from a client device.

The decision support system of the present invention may include tools and resources, which may be located or included on a resource server. The resource sewer may be in communication with the decision support server via a network to support the user in making decisions relating to the educational goals. The decision support system of the present invention may also include a web application on a web server. The web server may be in communication with the decision support server via the network. The web application may be accessed by the client device via the user interface.

According to an embodiment of the decision support system of the present invention, the user profile may be a student profile, a parent profile, an advisor profile, a higher education institution representative profile, or an administrator profile. The parent profile may monitor a student profile. The advisor profile may monitor the student profile and select the action to be recommended by the decision support server regarding the student profile. The higher educational institution representative profile may monitor the student profile. The administrator profile may manage the plurality of user profiles.

The user profiles may include private parameters and public parameters. The public parameters may be viewable by a higher educational institution. The private parameters may not be viewable by the higher educational institution. The decisions support system of the present invention may also include an admission application module on the decision support server. The admission application module may include admission applications accessed from the databases. The admission application module may populate fields included in the admission applications with the set of parameters included in the user profile.

The decision support system of the present invention may include an application submission module on the decision support server. The application submission module may allow the user to select a higher educational institution and upload parameters to apply for enrollment to the higher educational institution.

The decision support system of the present invention may include a competition module on the decision support server. The competition module may host academic competitions between the user profiles. The user desirous of entering one of the academic competitions may make a submission using the competition module. The competition module may receive rating information from other users via the user interface directed to the submission. The competition module may store the rating information in the databases.

According to an embodiment of the present invention, the competition module may analyze the rating information stored in the databases to determine the user profile with a highest rating. The competition module may base this determination on the rating information stored in the database. The competition module may transmit the notification to the user profile having the highest rating.

The decision support system of the present invention may include a guide module on the decision support server. The guide module may include a national benchmark profile on the database server, including national averages. The guide module ray compare the user profile and the national benchmark profile to determine variances between the set of parameters and the national averages. The guide module may also analyze the variances and recommend the action based on the variances.

The decision support system of the present invention may further include a financial literacy module on the decision support server. The financial literacy module may award points for compliance with the action recommended by the decision support server. The points may be exchanged for rewards. The decision support system of the present invention may still further include an emergency notification module on the decision support server. The emergency notification module may monitor the user profile for undesired behavior. The emergency notification module may also generate an emergency notification to an advisor indicating that the undesired behavior has occurred. Furthermore, the emergency support module may generate a notification to indicate that the undesired behavior has occurred in the set of parameters included in the user profile. The decision support system of the present invention may also include a validation module on the decision support server. The validation module may verify that the set of parameters included in the user profile is accurate and in compliance with the rules prior to storing the set of parameters in the databases.

A method aspect of the present invention is directed to using an educational decision support system to make a decision relating to educational goals. A method may include comparing the user profile with the performance metric and using a decision support module of the decision support server to compare a parameter from the set of parameters with the performance metric. The decision support system may additionally compare the user profile and the benchmark profile, determining variances between the parameter and the performance metric. Additionally, the decision support system may analyze the variances between the parameter and the performance metric, and may recommend an action based on the variances. The decision support system may also present a notification to a user based on the variances using a user interface.

The method may also include comparing a plurality of user profiles to determine the educational goals that are substantially similar. The decision support system may further recommend collaboration among the plurality of user profiles with the educational goals that are substantially similar.

The method may also include prompting the user for the set of parameters to be used to generate the user profile. The method may additionally include populating fields included in admission applications with the set of parameters included in the user profile. The user may select a higher educational institution and upload the parameter to apply for enrollment to the higher educational institution.

### BRIEF DESCRIPTION OF THE DRAWINGS

FIG. 1A is a block diagram illustrating a decision support system in accordance with an illustrative embodiment of the invention.

FIG. 1B is a block diagram illustrating the decision support server of FIG. 1A.

FIG. 1C is a block diagram illustrating a decision support system in accordance with another illustrative embodiment of the invention.

FIG. 1D is a block diagram illustrating the decision support servers of FIG. 1G.

FIG. 2 is a flowchart diagram in accordance with an illustrative embodiment of the invention.

FIG. 3 is a flowchart diagram in accordance with another illustrative embodiment of the invention.

FIG. 4 is a flowchart diagram in accordance with another illustrative embodiment of the invention.

FIG. 5 is a flowchart diagram in accordance with another illustrative embodiment of the invention.

FIG. 6 is a flowchart diagram in accordance with another illustrative embodiment of the invention.

FIG. 7 is a block diagram illustrating business rule processing that may be carried out by the decision support system of FIG. 1A.

FIG. 8A-8D shows interface diagrams in accordance with an illustrative embodiment of the invention.

FIG. 9 is an interface diagram in accordance with another illustrative embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way Other embodiments of the present invention will readily suggest themselves to such skilled persons having the benefit of his disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

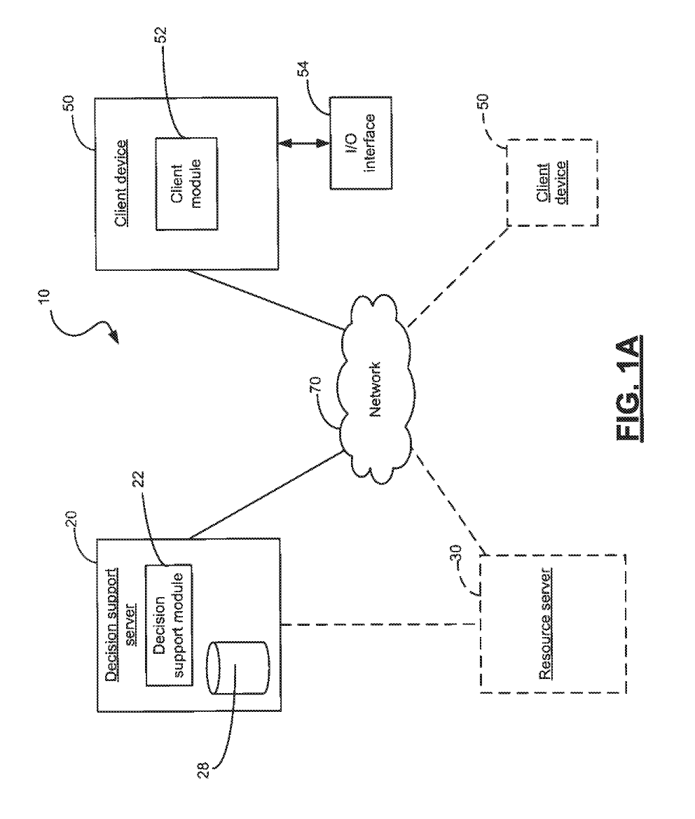

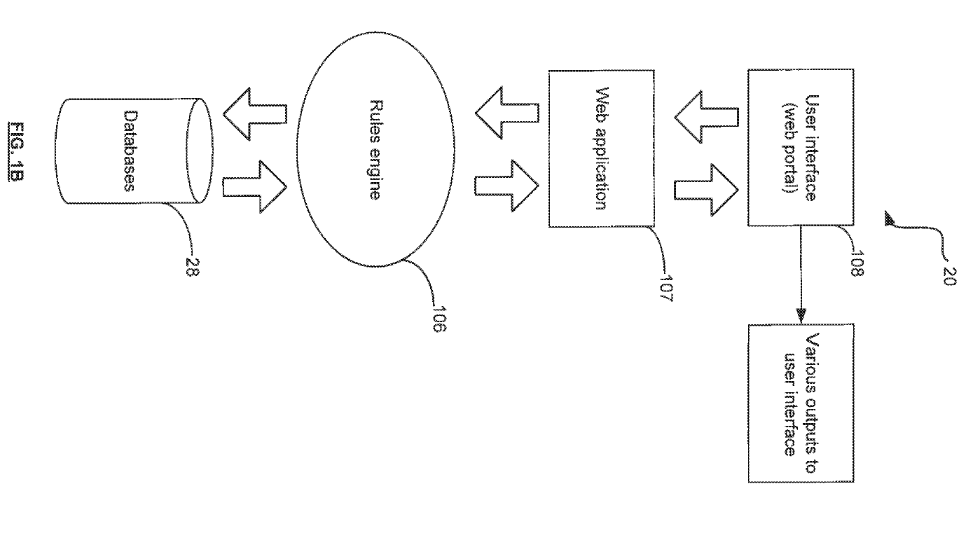

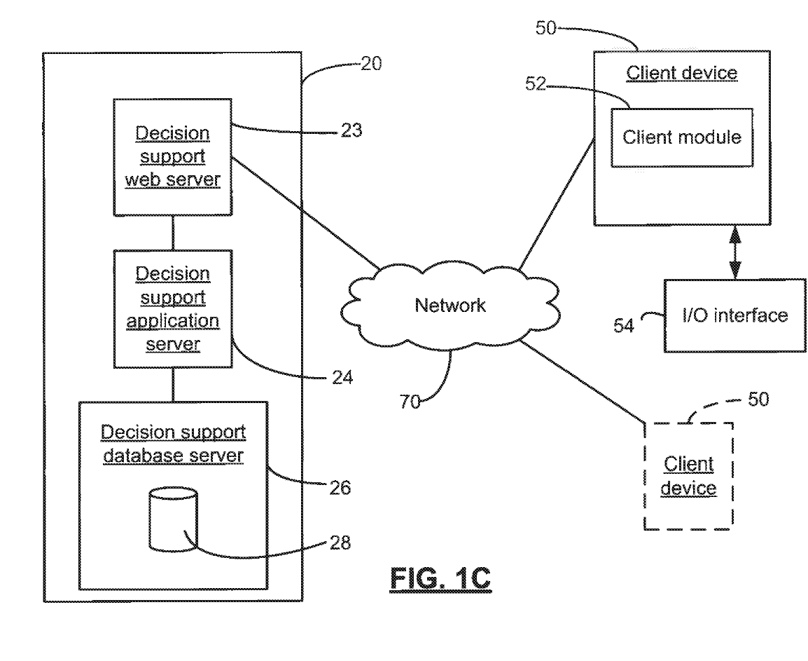

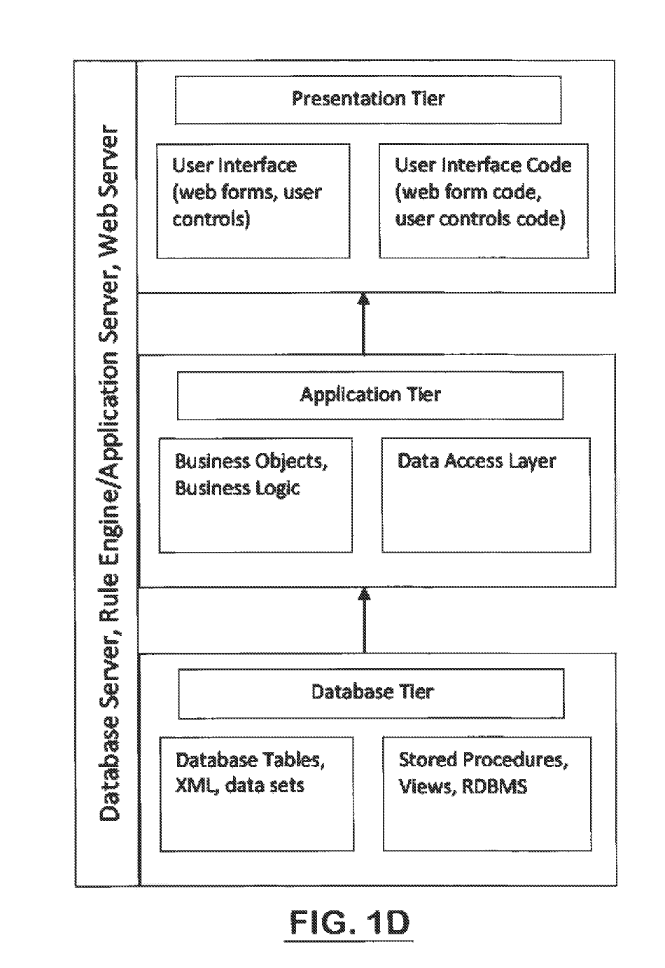

Referring now to FIGS. 1-9, an educational decision support system 10 according to the present invention is now described in greater detail. Throughout this disclosure, the educational decision support system 10 may also be referred to as a decision support system, a system, or the invention. Alternate references of the decision support system 10 in this disclosure are not meant to be limiting in any way.

In the following disclosure, various elements may be described to manipulate and analyze data stored within one or more databases 28. As would be appreciated by a person of skill in the art, these elements may be operated on a computerized system. Additionally, the various illustrative program modules and steps disclosed herein may be implemented via electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints.

Provided as a non-limiting example, the various illustrative program modules and steps, described in connection with the embodiments disclosed herein, may be implemented or performed via a computerized device. Such computerized devices may include, but should not be limited to, an application specific integrated circuit (ASIC), a field programmable gate array (FPGA), other programmable logic device, discrete gate logic, transistor gate logic, discrete hardware components, conventional programmable software module and a processor, or any combination thereof that may be designed to perform the functions described herein.

The processor may be a microprocessor, CPU, controller, microcontroller, programmable logic device, array of logic elements, or state machine. The software module may reside in random access memory (RAM), flash memory, read only memory (ROM), erasable programmable read only memory (EPROM), electrical erasable programmable read only memory (EEPROM), hard disk, removable disk, CD, DVD or any other form of storage medium known in the art. As will be appreciated by skilled artisans, a processor may be operatively connected to the storage medium to read and write information to and from the storage medium, respectively. Alternately, the storage medium may be integrated into the processor.

Those skilled in the art will appreciate that the foregoing methods may be implemented by executing a program located within a computer readable medium. The medium may include, for example, RAM accessible by or residing within the device. The program modules may additionally be stored on a variety of machine readable data storage media Such media may include a hard drive, magnetic tape, electronic read-only memory (ROM or EEPROM), flash memory, an optical storage device (CD, DVD, digital optical tape), or other suitable data storage media.

Referring now to FIG. 1A, the decision support system 10 of the present invention will now be discussed. The decision support system 10 of the present invention may include a decision support server 20 and one or more client device 50. The client devices 50 may be communicatively connected to the decision support server 20, for example, over a network 70. A person of skill in the art will appreciate additional data connections, which may allow the decision support server 20 to communicate with a client device 50 to be included within the scope and spirit of the present invention.

The decision support server 20 may include a decision support server 20 and a decision support web server 23. The decision support web server 23 may additionally be referred to below as a web server 23. Skilled artisans should appreciate that this alternate moniker may be used without the intent to limit the present invention in any way. The web server 23 may host a web application 107 configured to provide decision support services accessible by the users via the client device 50. Alternately, as perhaps best illustrated in FIG. 1C, the decision support server 20 may include web server 23, application server 24, and database server 26 in communication with each other to provide decision support services and resources to users via a connected client device 50.

Referring back to FIG. 1A, the client device 50 may include a client module 52. The client device 50 may also display a user interface 108 to provide interaction with the decision support server 20. The decision support system 10 may optionally include a resource server 30, which may be communicatively connected to the decision support server 20 and/or the client devices 50. The resource server 30 may be configured to deliver educational tools or resources, which may be recommended by the decision support server 20 to a user operating a client device 50.

Referring now to FIGS. 1A-1D the decision support server 20 will now be discussed. The decision support server 20 may be communicatively connected to one or more client devices 50 by way of a network 70, such as the Internet. For clarity in the following disclosure, references to client devices 50 will be made with respect to a single client device 50. A person of skill in the art will appreciate, however, that a plurality of client devices 50 may be connected to a decision support server 20 within the scope of the present invention. Therefore, skilled artisans should not view the following disclosure to limit the decision support system 10 of the present invention to include only one client device 50.

The decision support server 20 may include a decision support server module 22 to perform the server and/or decision support operations. The decision support server 20 may also include a data repository for storing information, such as user profile parameters, benchmark information and business rules. The decision support module 22 may additionally be referred as the decision support server 20 in the following disclosure, without any intended limitation to the present invention.

Provided as a non-limiting example, the decision support server 20 may be a single computing device, having a processor and memory. Alternately, the decision support server 20 may include multiple computing devices communicatively connected, such as, for example, in a distributed cloud-based architecture. The decision support module 22 may manage the communication between the decision support server 20 and the client device 50. The decision support module 22 may also manage the storage of data in the memory and/or database 28, analyze user profiles, and process rules via a rules engine 106.

The decision support server 20 may include user profiles defined for each of the users. The user profiles may be stored in a database 28, which may be managed by the decision support server 20. A user profile may include a set of parameters, which may be used to store specific attributes about the user. Parameters may include details such as, but not limited to, name, date of birth, class schedule, teachers, locker number, grades, interested higher educational institutions, awards, accolades, or a plethora of additional information that may be associated with a user. A person of skill in the art will appreciate that the parameters associated with a user profile may be customizable.

The decision support server 20 may include benchmark profiles, defined as profiles that may be used to compare with a user profile to determine educational progress. The benchmark profiles may be stored in the database 28, which may be managed by the decision support server 20. A benchmark profile may include a set of performance metrics, which may be used to store specific benchmark attributes to be compared with the user profile. Performance metrics may include details such as, but not limited to, recommended class schedule, optimal teachers, deadlines, recommended grades, recommended higher educational institutions, award goals, accolade goals, or additional information that may be associated with a user. A person of skill in the art will appreciate that the performance associated with a benchmark profile may be customizable.

The decision support server 20 may also include a web application 107 and a web portal to providing a user interface 108 that may be accessed by the client device 50. The decision support server 20 may additionally include an application server 24 to manage and analyze business objects, business logic, and/or rules.

The decision support server 20 may include a rules engine 106, which may access rules included in the database 28 to determine variances between a parameter and a performance metric. After determining a variance, the rules engine 106 may analyze the variance to determine an action to recommend to a user. As a non-limiting example, the user may view the recommendation via a client device 50.

As perhaps best illustrated in FIGS. 1B-1D, the decision support server 20 may be implemented as a plurality of servers using a tiered architecture. As an example, the decision support server 20 may include three tiers. In this example, the tiers may include a presentation tier, application tier and database tier. An illustrative structure of the aforementioned tiers may perhaps best be shown in FIG. 1C.

The following three level tier structure is now disclosed as an illustrative embodiment of the tier structure, according to an embodiment of the decision support system 10 of the present invention. A person of skill in the art should appreciate the inclusion of additional tiers, and should not view the present invention to be limited to the tier structure disclosed in the following example.

The database tier may include databases 28 and a database server 26. The database server 26 may manage and analyze the data included within the databases 28. The databases 28 may include data used by the decision support system 10 of the present invention to analyze and suggest a recommended action. Data defined within the databases 28 may include parameters, performance metrics, rules, business logic, national benchmarks, or any other information that may be stored electronically.

The decision support database server 26 may include a data repository, or database 28. The database server 26 may also support database tier functions, such as storing and accessing data from the databases 28 which may include user profile data, benchmark information and other resources.

The application tier may include the application server 24, which may manage the business objects, business logic, and/or rules. The application server 24 may operate as part of a data access layer. The application tier may additionally include a web application 107, which may control managing data included within the database 28. Managing data may be performed via operations, methods, classes, or other software components that may be used to analyze or manage data. The application server 24, and additional components included in the application tier, may access and manipulate the data included in the databases 28 included in the database server 26.

The rules engine 106 may apply rules based business logic to parameters included in the user profiles. The rules engine 106 may also apply rules to the performance metrics included in the benchmark profiles. The rules engine 106 may analyze the parameters, performance metrics, and/or variances between the parameters and the performance metrics, at the application tier.

The presentation tier may include a user interface 108, which may allow a user to interact with the application server and access the data included in the databases 28 of the database server 26. Skilled artisans will appreciate that a web interface may be a type of user interface 108 that may be accessed via a network 70. The user interface 108 may be accessed by the clients via a client device 50. The user interface 108 may additionally include web forms and user controls. The user interface 108 may be comprised of components generated from web form code and user control code.

The presentation tier may include the decision support web server 23. A decision support application server 24 may be included in the application tier. A decision support database server 26 may be included in the database tier. The functions of the decision support module 22 may be distributed across these servers. The decision support web server 23 may include program modules which may operate functions performed at the presentation tier. The presentation tier functions may include, but should not be limited to, the generation of user interface components. Examples of user interface components may include, but should not be limited to, clickable links, performance dashboards, and profiles. Optionally, the interface components may be customized by users and administrators of the system.

Provided as a non-limiting example, the decision support server 20 may be operated on a single computing device, having a processor and memory. Alternately, the decision support server 20 may be operated across multiple computing devices, which may be communicatively connected in a distributed cloud-based architecture. The decision support system 10 also may include one or more client device 50, which may further include a client module 52 and an input/output (I/O) interface 54.

The decision support system 10 may include one or more client device 50. As mentioned above, a client device 50 may include a client module 52 and an I/O interface 54. Provided as a non-limiting example, the client device 50 may be a computing device that includes a processor and memory. Examples of suitable computing devices may include a personal computer, smartphone, mobile phone, or a personal digital assistant. The client device 50 may include a keyboard, mouse, monitor, touch screen or similar device that may be suitable for allowing a user to interact with the connected decision support server 20.

The client module 52 may manage the communication between client device 50 and the decision support server 20. The client module 52 may additionally provide the user interface 108 to a user, allowing the user to interact with the decision support server 20.

The client module 52 may additionally manage communication with a decision support web server 23. More specifically, the user interface 108 provided by the client module 52 may allow a user to interact with the decision support web server 23. The decision support web server 23 may be communicatively connected to the client device 50 by way of a network 70, such as, for example, the Internet.

The decision support system 10 may additionally include a resource server 30, which may provide educational content or software training tools. The resource server 30 may be included as a component of the educational decision support system 10 of the present invention. Alternately, a user may access one or more third party resource server 30 connected to the decision support system 10 of the present invention via a network 70, such as, for example, the Internet. More specifically, the resource server 30 may be communicatively connected to the decision support server 20 by way of a network 70, such as, for example, the Internet. Additionally, the resource server 30 may be connected to the client device 50 locally or via a network 70 connection.

The resource server 30 may be configured to provide resources, such as educational content or software training tools. Examples of software training tools may include software-as-a-service tools. The decision support system 10 may recommend and deliver the resources included in the resource server 30 to users.

The resources available through the resource server 30 may be indexed and logged in a database 28, which may be included in the database server 26. The database 28 may include database tables and/or resource tables, which may store and organize data. The resource tables may be stored locally on the decision support server 20, decision support database server 26, or a third-party resource server 30. The resource tables may store information regarding the resources available. Available resources may include, but should not be limited to articles, webinars, tutorials, games, or software-as-a-service resources, tutor-on-demand, career planning tools, interest and capability assessments, and video libraries.

The decision support system 10 may include a notification module, which may transmit a notification to a user upon the occurrence of an event. A notification may include information that is intended to be delivered to a user. The notification module may select the notification to be sent to the user based on analysis of the variance that has been determined by the rules engine 106. A person of skill in the art will appreciate that the notification module r nay generate and transmit one or more notices, as may be determined by the variance and the rules engine 106.

The decision support server 20 may additionally include a collaboration module to recommend collaboration. The collaboration module may determine whether collaboration may be beneficial by analyzing the educational goals of the user. Educational goals may be stored as parameters in a user profile for a corresponding user. The collaboration module may analyze the user profiles of additional users to determine whether additional users exist with substantially similar educational goals. The collaboration module may then recommend collaboration between users with similar educational goals.

The collaboration module may perform analysis of user profiles to determine a plurality of users that may be well-suited to form a group for purposes of collaboration, such as a study group. The collaboration module may consider matching factors, such as, for example, whether the users are in the same grade level or enrolled at the same school. The decision support server 20 may also select a particular user from the suggested group of users to serve as the leader of the group. The collaboration module may analyze the parameters included within the user profiles of the group to determine the leader of the collaboration. By selecting the appropriate group leader, the decision support system 10 of the present invention may advantageously increase the group's chance of success in accomplishing their educational goals.

The collaboration module may transmit a notification to the users included in the group, recommending the collaboration. The collaboration module may transmit the notification via the notification module. The notification may include an indication to a potential group leader. The notification may additionally include names of the other users that may participate in the group. The decision support server 20 may additionally support the effectiveness of the collaboration by including peer review of content, online competitions, forums and other educational tools and resources.

Using the collaboration module, the decision support system 10 of the present invention may provide a number of ways to establish collaboration between users. Collaboration may include, for example and without limitation, virtual web-meetings, email, and discussion boards.

Based on information a student user may include in their profile, the decision support module 22 may search through the resources included in the resource server 30 to identify resources that may benefit the user. When relevant resources are identified, the system may push the recommendations to the user interface 108 indicating the resource. When the student user logs into the decisions support system 10, he or she may review the latest recommendations and access instructions on how to use to the resource.

The decision support server 20 may also perform analysis of data exchanged during such collaboration to detect potentially problematic behavior. Examples of problematic behavior may include, but should not be limited to, inappropriate language, indications of bullying, indications of depression/suicide, or other problematic behaviors that would be appreciated by a person of skill in the art. Upon a determination of problematic behavior, the collaboration module of the decision support server 20 may provide notifications of the detected behavior to an appropriate administrator of the system.

As mentioned above, users of the decision support system 10 of the present invention may create user profile. The user profile may include parameters, which may correspond to details about the user. A benchmark profile may also be included in the decision support system 10 of the present invention. The benchmark profile may include performance metrics. The rules engine 106 may compare the parameters of the user profile with the performance metrics of the benchmark profile to create variances.

The user profiles may be stored in databases 28, included within the decision support server 20. More specifically, the parameters that define the user profiles may be stored in the database server 26, as it is defined on the database tier of the decision support server 20.

Various user profile types may be created in the decision support system 10 of the present invention. Provided as a non-limiting example, profile types may include a student profile, parent profile, advisor profile, higher educational administrator profile, and administrator profile. As stated above, the decision support system 10 of the present invention may additionally include benchmark profiles. Each of these illustrative profile types will be discussed in more detail below. Once created, the user profiles may be data mined, or scoured for data that the decision support server 20 may analyze.

The plurality of user profile types may have unique sets of data related to each type. For example, a student user profile may include a plurality of parameters to describe details about the student user. Such parameters may include, for example, age, grade, GPA, detentions, locker number, home address, teachers, or other information that may pertain to the student user. Additionally, the parameters associated with the student user may be compared with performance metrics by the rules engine 106, determining variances from which a suggested action may be determined.

In a variation of the present invention, three sets of student profiles may be created. First, a unique student profile may be created for every student user. Additionally, targeted profiles may be created by account types under a classification, such as a higher educational institution. Finally, grade-level benchmark profiles may be created to define the performance metrics to which the student users may aspire. The benchmark profiles may be updated at regular intervals, such as each year. These grade-level benchmark profiles may be defined according to research of typical student progress. Additionally, the benchmark profiles may assist a school in creating yearly guidance plans tailored to each student user.

The decision support system 10 may also support additional user account types for parents. The decision support server 20 may allow parent users to create a parent user account. Through the parent user account, parent users may optionally create user accounts and user profiles for children.

Additionally, a parent user profile may be associated with one or more student profiles. The associated student profile may be that of a child of the parent user. The parent user may access his or her parent profile to view parameters included in the associated student profile. Optionally, selected parameters of the student user profile may be masked from the view of the parent users. These masked parameters may be set by an administrator user, student user, or other user that may use the decision support system 10 of the present invention.

The decision support system 10 of the present invention may be integrated with a school district's record systems. If integrated, the parent users may access select data from student academic records, which may be stored as parameters in the student profiles. The parent user may also access course offerings. The parent users may then advantageously work with their children to strategically plan the student user's educational goals. Parameters of the student user profile may be additionally analyzed by the decision support system 10 to determine whether it would be in the student user's best interest to engage guidance counselors in the planning of the educational goals for the student user.

Representatives of educational institutions or professional organizations may additionally create a user profile. The decision support server 20 may allow users having an educational institution representative account type to search student user profile data and determine student users that may be a good fit for attending their institution. The higher educational institution user may access the decision support system 10 of the present invention for recruiting purposes.

In one embodiment of the decision support system 10 of the present invention, the decision support server 20 may push student data to a higher educational institution representative user account. Alternately, the decision support system 10 may perform a user initiated search. The decision support system 10 of the present invention may pull data from the student profiles. The decision support system 10 may also perform an automated transmission of matching student users to a higher educational institution user account. A person of skill in the art will appreciate additional search mechanisms for a higher educational institution representative user account to access and analyze the data included in the student user accounts.

Additionally, the user profile data provided by a higher educational institution representative may be stored in a profile database, which may be included as a database 28 in the data repository. The information included in the profile database may be accessed and analyzed by the decision support server 20 upon calling a corresponding operation.

The decision support system 10 of the present invention may include advisor user accounts. The advisor user account may provide third-party monitoring of a student user's progress. As will be understood by a person of skill in the art, one or more users may be an advisor.

The advisor may monitor the progress of student user or other types of users. Upon detecting a variance of a threshold for a particular user, the decision support system 10 may provide a notification to the advisor user relative to the variance, which may be associated with that user. The advisor user may then provide more personalized support to the student user to ensure their educational success.

Additional notification messages may also be supported, such as a message notifying an advisor that a one-on-one meeting should be held. Alternately, a notification may be transmitted that a one-on-one meeting has recently been missed. The decision support system 10 may also be configured to allow student users to provide anonymous ratings of the advisors. The anonymous ratings may be given, for example, by way of surveys or comments received from the student users.

The decision support server 20 may also allow student users to elect to have their profiles publicly viewable. More specifically, users may elect to make some or all of the parameters included in the user profile publically viewable. Parameters that are not publically viewable may be considered private parameters. A user profile with no parameters publically viewable may be defined as a private user profiles.

Colleges and universities which have registered with the decision support system 10 may search and view public parameters included in student user profiles for admission recruiting purposes. Parent users may also set up accounts and access a parent web portal, or web interface. Parent users may also set up accounts on behalf of their children.

The educational decision support system 10 of the present invention may include one or more benchmark profiles. The benchmark profile may include performance metrics, which may be user defined and/or derived from benchmark profile data. A person of skill in the art will appreciate additional sources for performance metrics to be included within the scope and spirit of the present invention.

While applying the rules defined by the rules engine 106 to the parameters included in a user profile, the decision support system 10 of the present invention may consider the performance metrics. The performance metrics may be user defined and/or derived from benchmark profile data. The rules engine 106 may use these performance metrics to determine variances, which may then be analyzed to make a recommendation. Additional analytics may be added to the variance determining process by adding additional information.

The following example is provided without the intent of limiting to the decision support system 10 of the present invention. For example, the decision support system 10 may determine that a student has less than optimal performance in his or her math and history courses. More specifically, the decision support server 20 of the present invention may compare the parameters included in the student's user profile with the performance metrics included in the benchmark profile. Upon the determination that the performance level defined by the parameters is below a threshold performance level, defined by the performance metric, the decision support system 10 may determine a variance. The decision support server 20 may analyze the variance to make a recommendation to the student user regarding techniques to improve performance in both math and history. In a specific and non-limiting example, the parameter and performance metric may define grade average within the course.

As an additional example, a student user may indicate a specific interest in history. This indication may be made via the web portal, web interface, or other interface that may be operated, for example, via a client device 50. Alternately, the decision support system 10 may analyze a documented educational goal of the student users desire to become an historian. As will be understood by a person of skill in the art, additional recommendations may exist to provide dynamic exposure and experience in history related educational opportunities to the student user.

As a specific example, presented in the interest of clarity and without the intent to be limiting, the decision support system 10 of the present invention may determine that a student user has an interest in anthropology. The decision support system 10 may then recommend a summer anthropology program, or other activities or courses, which may provide a more full exposure and experience for the student in the area in which they have documented interest or aptitude.

Additionally, the system may provide a weighting system to prioritize recommendations. The recommendations may be weighted according to a ranking, which may be a determined via parameters and performance metrics provided by the student, administrator, parent recruiters, advisors, and/or variety of additional data sources that would be appreciated by a person of skill in the art. Any data entered or captured by the system captures may be used to provide comprehensive guidance to a student user.

The decision support system 10 may include an admission support module to include admission applications, which may be accessed by a user from a database 28 stored on the database server 26. Alternately, the admission applications may be accessed from a remote source connected to the decision support system 10 of the present invention, for example, via a network 70.

A person of skill in the art will appreciate additional applications of the decision support system 10 of the present invention, such as, for example, may be used by adults, professionals, schools, employers, states, and similar entities. As a student user may transition from high school into college, and eventually the workforce, the application module of the decision support system 10 may provide automated resume analysis and maintenance. The application module may analyze the information included in the resume for key triggers, such as the last update date. If a certain period, for example, six months, has passed with no updates to a resume of a user, a notification may be sent to the user. Examples of sending techniques may include email and/or posting a notice to the user's web interface or portal. The notice may further include a link, which may open a structured form to provide the latest career information. Users may advantageously have persistent access to their most current resume, rather than having to extensively modify when needed.

Additionally, the decision support system 10 of the present invention may track professional certifications that may be desired in a particular career or field. The decision support system 10 may analyze the professional certifications of the user and make recommendations to users on that professional track regarding additional certifications that may be beneficial to furthering the user's educational or career goals.

The decision support system 10 of the present invention may include an application submission module that may upload one or more parameter to a higher educational institution. The uploading of parameters may be accomplished via push and pull data mining capabilities. Pull data mining may be defined as allowing a higher educational institution representative user to search profile data and pull desired profile information, such as parameters, from the database 28 included in the decision support system 10. Additionally, the decision support server 20 may support push data mining and analysis by automatically pushing student user profile information, such as parameters that may match a set of searched parameters, to a higher educational institution. The push operation may be performed in response to a request from a user, such as a representative of a higher educational institution.

The push and pull data mining operation, as may be performed by the application submission module of the decision support system 10, may be facilitated through the creation of targeted profiles. Provided as a non-limiting example, targeted profiles may be profiles created by a college representative user to find students that meet desired entrance requirements. Targeted profiles may be a type of benchmark profile including application specific performance metrics. Multiple target profiles may be created by a college representative user to find students that may meet general or program-specific entrance requirements.

The decision support system 10 may search the database 28 of student profiles to find the student profiles that match the targeted profiles. The decision support system 10 may determine the student profiles to include in the search results by comparing the parameters included in the student profiles with the performance metrics included in the benchmark or targeted profiles. The application module may then push the information to the college representative user's web interface or portal, which may be accessible via a client device 50.

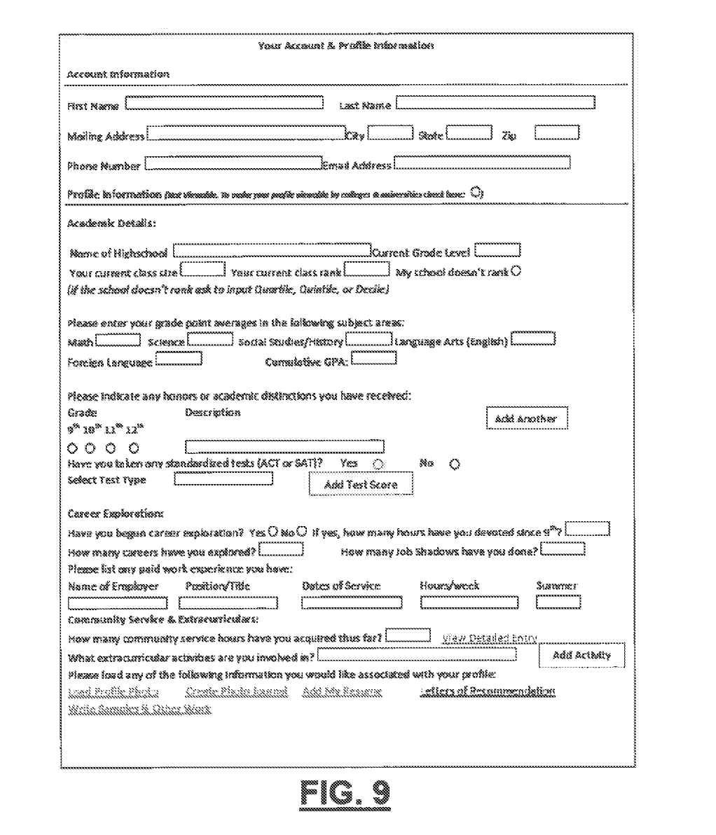

Alternately, the student user may provide data via another form, such as, for example, the information submission form illustrated in FIG. 9. This data may also be stored as parameters in a user profile, in the data repository from which searches and analytics may occur.

As previously mentioned, the decision support system 10 of the present invention may be used for job search assistance and/or college search assistance. In this embodiment, the decision support system 10 may match user profiles with employers and/or colleges and universities. The decision support system 10 of the present invention may allow colleges and universities to define information and parameters to capture in the admissions applications. This information may be subsequently incorporated in student profiles to facilitate integrated and semi-automated college application submission. Students may advantageously select a college, upload their data and/or parameters, review the application for accuracy, and transmit the application to the desired higher educational institution. Preferably, the transmission may be performed electronically. However, a person of skill in the art will appreciate additional application transmission methods to be included within the scope and spirit of the present invention.

The decision support system 10 of the present invention may include a competition module, which may organize and manage competitions among users. Online competitions may be offered through the web interface, or web portal. Provided as a non-limiting example, competitions may include essays, poetry, art, music, and math contests. The system may enable the content generated in each of these competitive forums to be reviewed by peers, or other users in the system. The peers may rate the competition submission to determine winners. The rating information may be stored within the database 28, which may be included in the database server 26. The competition module may then analyze the rating information to determine the winner. The competition server may then notify the user that has been determined as the winner of the winning determination.

In an additional example of the competition module, a user may review specific pieces of content, such as a particular tool that is licensed or an available tutorial. The user reviews may be collected by the decision support system 10 and analyzed to determine whether a tool and/or resource should be updated or expanded. For example, positive review feedback provided by users may determine that certain tools are more useful than others. The decision support system 10 of the present invention may then automatically update the tools, tutorials, and other resources that may be recommended to users of the system, based on the ratings received by the users. Thus, the system may advantageously recommend the most popular and well-received resources and tools.

The decision support system 10 of the present invention may include a guide module that may compare parameters included within student user profiles with national averages included within a national benchmark profile. Once a significant quantity of users may utilize the decision support system 10 of the present invention, the data analysis occurring in the system becomes statistically significant and may be generalized. The generalized statistical data may broadly represent the national student population. This broad representation may allow the automated and dynamic modification of rules logic. The automation of rule generation may replace the need for manual rule creation, manipulation, or updating. The decision support system 10 of the present invention may also dynamically modify recommendations, visible content, and a plethora of other various data sets. This modification may occur approximately instantaneously, or in real-time, in response to the data analysis that may occur on the national level.

For example, when colleges and universities change entrance requirements as noted in their target student profiles, the system can aggregate and analyze the data across all the colleges in the system. The aggregation may occur with respect to the specific performance metrics, such as subject area or test scores. The decision support system 10 may the automatically update the twelfth grade benchmark student profile. This ensures that the benchmark profiles remain current and accurate.

The national benchmark profile may be analogous to the benchmark profile, wherein the national average of the national benchmark profile may be compared to the parameters included within the student profile to determine variances. The variances may then be used to recommend an action to further the student user's academic progress. This comparison may be similar to the comparing parameters with performance metrics included in a benchmark profile. However, a person of skill in the art will appreciate that the national benchmark profile may include educational performance information that has been assimilated from large number of student profiles across an extended geographical region.

The guide module, which may be located on the decision support server 20, may analyze user profile data and parameters with national benchmark profiles and business rules to provide a recommended resource and/or set of actions to a student user. The student user may access these recommendations via a client device 50. By the decision support system 10 recommending an action, as determined by analyzing national benchmarks, a student user may advantageously make a beneficial educational decision.

The guide module may enable proactive and automated performance management for users. The guide module may also include an additional step that may use data analysis and performance management framework to enable an additional type of user profile, such as an educational advisor user. The advisor user may manage a given portfolio for the student users the advisor may be advising. Here, different sets of data and activity captured in the web application 107 may be monitored using data analysis. Various notifications may be provided based on rules. The monitored data may additionally be recorded in the user profile as parameters.

The decision support system 10 of the present invention may include a financial literacy module to provide incentives for educational progress. Using the financial literacy module, student users may earn and accumulate points. The student users may use these points to purchase rewards, such as via an online store available through the web interface or portal. The students may earn points for complying with the actions recommended by the decision support system 10, further incentivizing the student users to meet their educational goals.

In another aspect, a points system may be provided that allows students to earn points, which may be accumulated in a virtual checking account. Provided as a non-limiting example, points may be earned when students meet their goals, log into the portal, complete a follow-up action, use a tutorial, complete an extra credit assignment, explore a career, participate in a study group, participate in an online competition, or interact with the system in any predetermined manner. The points may be used as incentives for students to perform the tasks that the system may recommend.

Points may provide an incentive for students to perform tasks or actions that the system may recommend. Provided as a non-limiting example, the points may be redeemed for cash or scholarships, which may be deposited into a college savings account. Alternately, provided as a non-limiting example, the points may be redeemed for prizes that may be purchased via a web store.

The points system offered by the financial literacy module may simulate financial impact scenarios and checking account transactions. For example, if a student user is spending points at a rate that may be greater than the points are earned, the decision support system 10 may send a notification to the student user of the impact to their financial status. The decision support system 10 may also recommend a spending budget. The decision support system 10 of the present invention may recommend actions to a user to increase disposable income. Savings accounts would also be offered to juxtapose the value of saving against the hazards of thoughtless spending. Through the use of the financial literacy module, the decision support system 10 of the present invention may advantageously expose users to financial fundamentals by analyzing data and parameters associated with a user profile and applying rules driven logic to provide guidance through the management of points.

The decision support system 10 of the present invention may additionally include an emergency notification module, which may monitor a user profile for undesired behavior. Undesired behavior may include use of target words, such as inappropriate language, or words that might indicate bullying, slandering, depression, suicide, or other undesired behaviors. Upon the detection of undesired behavior, the emergency notification module may generate an emergency notification to be received by an advisor indicating the undesired behavior. The emergency notification module may additionally record the event relating to the undesired behavior as a parameter in the user profile.

Provided as a non-limiting example, a student user may be on the phone with an advisor, wherein the student may make a statement that raises concerns about the student user's safety and well being. Concerns may include, for example, indications that the student user is depressed or suicidal. The advisor may alter the decision support system 10 of the concern, such as pressing a “red phone” alert button on the user interface 108. The advisor may then keep the student user on the line while the appropriate parties are automatically notified via, for example, system generated emails, texts, and/or phone calls.

The emergency notification module, which may be included in the decision support system 10 of the present invention, may monitor student user profiles, chat-rooms, collaborations, and study groups to monitor for undesired behavior. The user profiles may be automatically flagged, via the recording of parameters. The flagged profiles may be brought to the attention of an administrator or staff psychologists to determine appropriate intervention action.

The decision support system 10 of the present invention may also provide features related to guidance counseling automation. The system may analyze student user academic data, which may be stored as parameters in a database 28, and compare the data against course catalog data for a given institution. The decision support system 10 may then provide, for example, a recommended class scheduling that would be tailored to the needs of the student user.

For example, based on the data analysis performed by the rules engine 106, the decision support system 10 may determine that a student user excels in English, geography and history, yet struggles in math and science. The student user may also be a junior scheduled to take chemistry and then physics. However, the logic included in the database 28 of the decision support system 10 may indicate that a state educational profile or criteria may allow a student user to enroll in a five course sequence of English courses to replace the chemistry and physics requirements. The decision support system 10 of the present invention may generate, or be programmed with rules to consider this educational criteria. The decision support system 10 may then apply the proper analysis, resulting in a recommendation in compliance with the aforementioned course scheduling consideration.

In this example, the decision support system 10 may schedule the student in the additional English courses to replace the chemistry and physics requirements. This selected scheduling may be based on the data analysis performed by the rules engine 106 applying the customized rules. The specific application of rules with regard to the individual student user may advantageously provide insight as to why a student may be placed in certain classes.

The decision support system 10 of the present invention may include a validation module to verify that the parameters included in a user profile are accurate and in compliance with the rules. This verification operation may be performed prior to storing the parameters in the database 28. The validation operation may occur as new user accounts may created. At the account creation, the parameters entered by a registering user may be validated within a certain period of time or entered data may be automatically deleted.

Ultimately, the decision support system 10 of the present invention may provide data driven decision support placing students in the appropriate and logical course schedule, which may tailored to the student user's individual educational and career success.

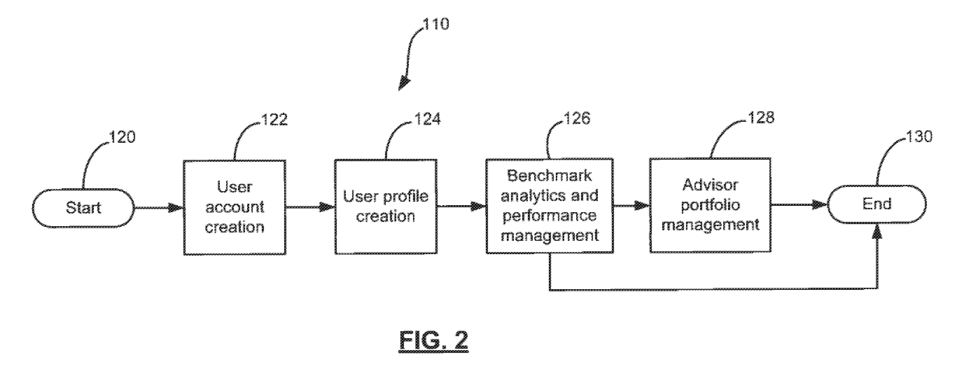

Referring now to the flowchart 110 of FIG. 2, the operation of an embodiment of the decision support system 10 of the present invention will now be discussed. The operation may begin at Block 120, wherein a user may create a user account (Block 122). Once a user account is created, the user may create a user profile (Block 124). The decision support system 10 of the present invention may then perform benchmark analytics and performance management, as shown in Block 126. Optionally, the decision support system 10 may additionally perform advisor portfolio management (Block 128) prior to the conclusion of the operation at Block 130.

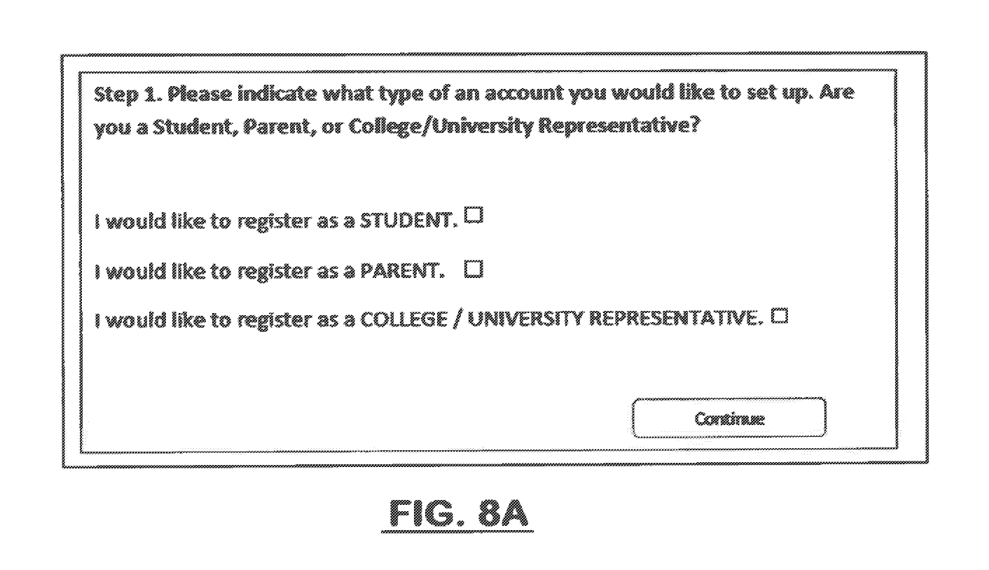

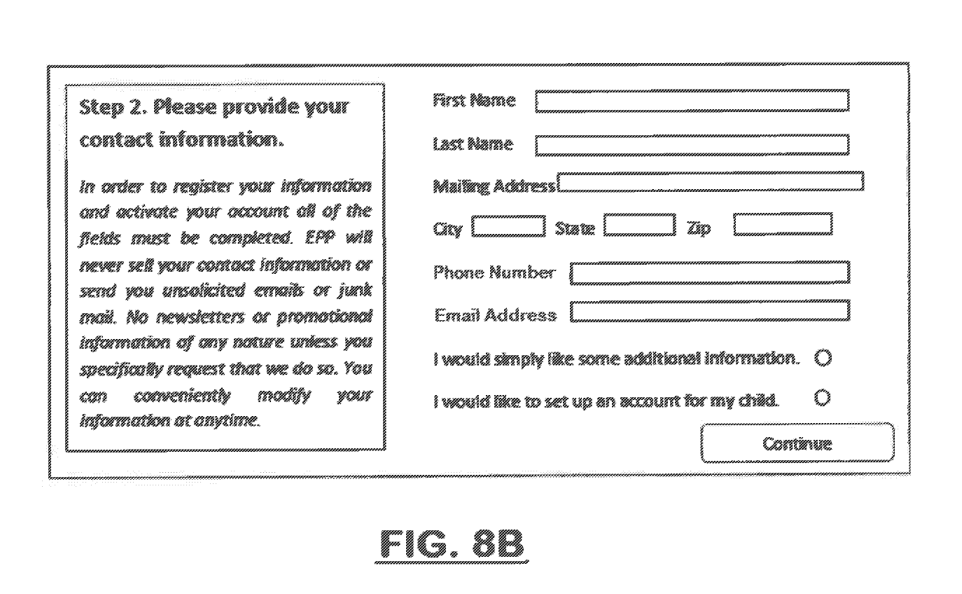

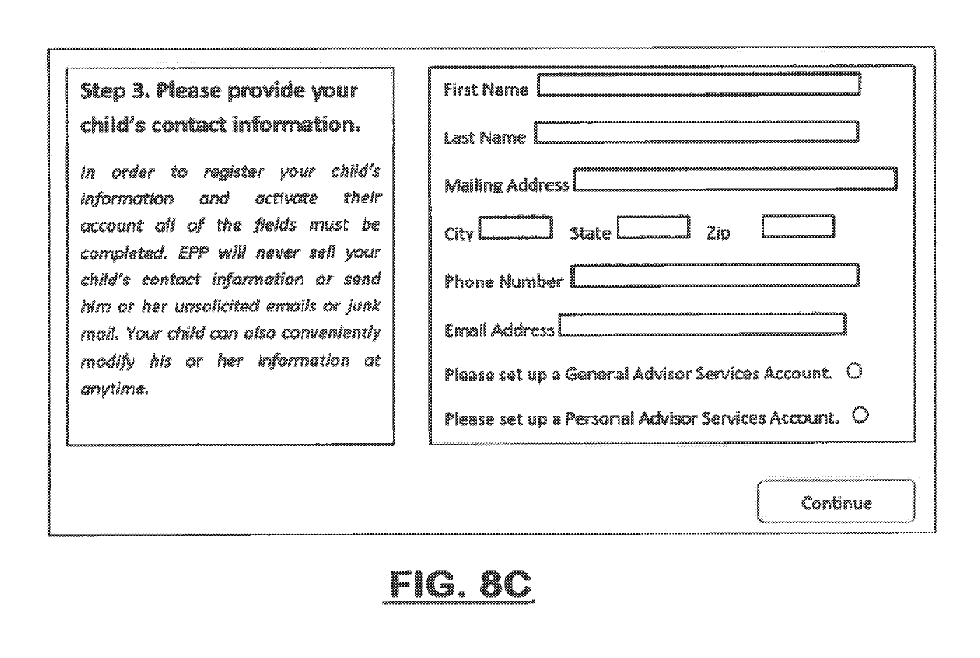

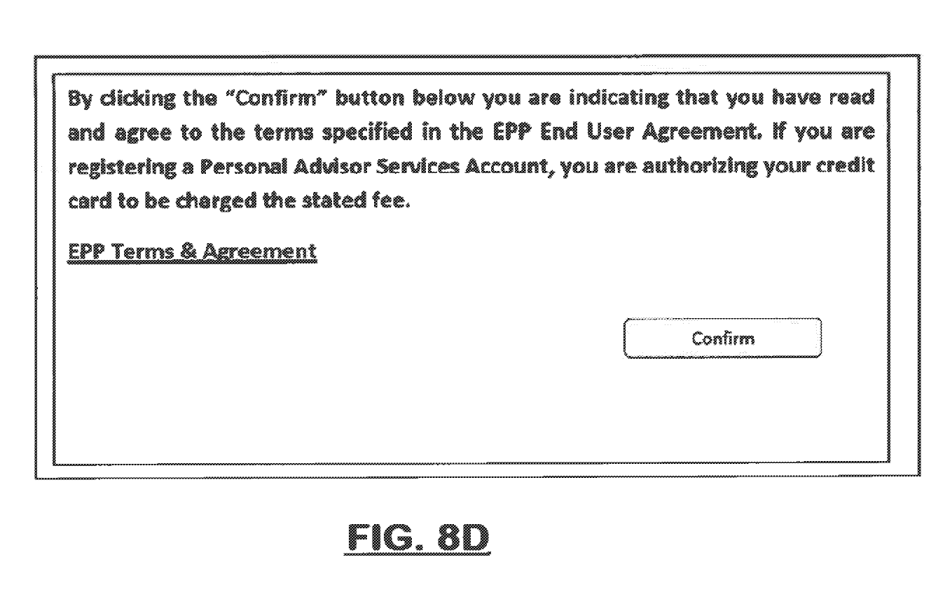

FIG. 8A-FIG. 8D illustrate model user interface elements that may be displayed on the client device 50 for the purposes of creating an account. After the user account is created, the decision support system 10 may assist the user in creating a user profile. The user profile may include user entered data, which may be defined as parameters which act as the basis for comparative data analytics and performance management functions provided by the decision support server 20. FIG. 9 illustrates model user interface elements that may be displayed on the client device 50 for the purposes of creating a profile for an illustrative student user.

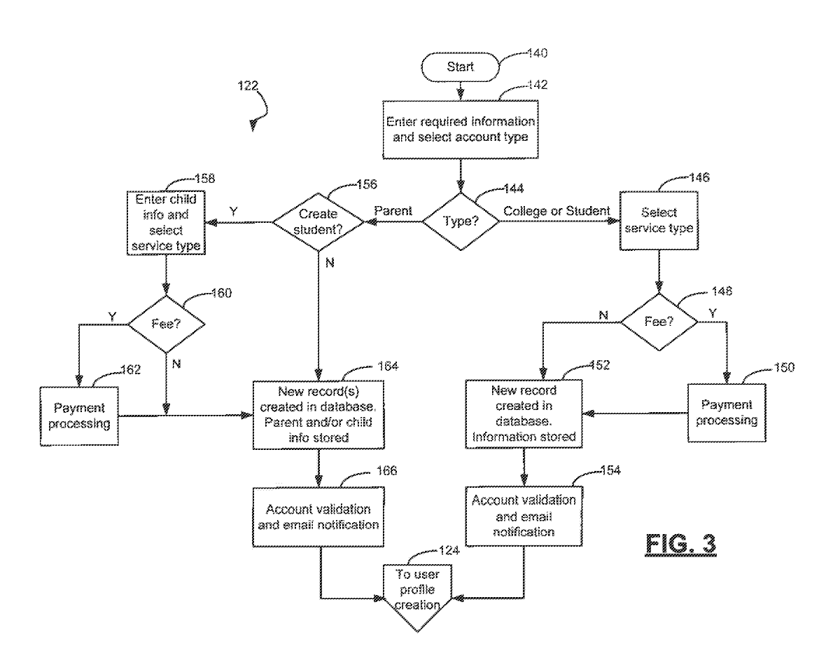

Referring now to flowchart 122 of FIG. 3, which expands the action described in Block 122 in FIG. 2, a computer implemented method of creating a user account will now be discussed. The method of creating a user account may include a series of steps, which may occur between a user operating a client device 50 and the decision support server 20. The user may be prompted to enter data via the user interface 108 and web application 107. An example of a user interface 108, which is presented without the intent to be limiting, may perhaps be best illustrated in FIGS. 8A-8D.

Starting at Block 140, the user account generation operation may begin by prompting a user to enter required information and select an account type (Block 142). The various user account types have been discussed above in greater detail. After the user has performed the actions requested at Block 142, the decision support system 10 may determine which account type has been selected (Block 144). For clarity, the present example will discuss a system herein a user may select an account type as either a student user or a parent user. A person of skill in the art will appreciate additional user account types, which have been described above. Additionally, skilled artisans should not view this given example as limiting the present invention to two user account types.

If the user selects to establish a student user account at Block 142, the user may select the services to be delivered by the decision support server 20 of the present invention (Block 146). The user account created by a student and/or representative of college or higher educational institution may be a free or fee based account, which may be determined at Block 148. If a fee is required for account creation, the decision support system 10 may direct the user to payment processing (Bock 150). The payment processing may be an online payment processing utility, used to collect payment.

Once payment has been processed, or if the account creation does not require a fee, a new record may be created in the database 28, storing the information entered by the user as parameters (Block 152). The information may be stored in a table in the data repository, based on the type of account being created. The decision support system 10 of the present invention may then perform account validation, after which it may optionally transmit an email notification (Block 154). Once the user account has been created, the user may create a user profile (Block 124).

If the user selects to establish a parent user account at Block 142, the user may be queried as to whether he or he may desire to create a student account on a student user's behalf (Block 156). If the parent user desires to create an account for a student user, he or she may move to the operation of Block 158, wherein the user may enter information related to the child and select the type of service to be rendered by the decision support system 10 of the present invention (Block 158). The user account created by a parent user may be a free or fee based account, which may be determined at Block 160. If a fee is required for account creation, the decision support system 10 may direct the user to payment processing (Block 162).

The payment processing may be an online payment processing used to collect payment. Once payment has been processed, or if the account creation does not require a fee, a new record may be created in the database 28, storing the information entered by the user as parameters, as represented by Block 164. The information may be stored in a table in the data repository, based on the type of account being created.

If the parent user does not desire to create an account for a student user, he or she may move to the operation of Block 164, wherein new records may be created in the database 28, storing parent and/or child information. The decision support system 10 of the present invention may then perform account validation, after which it may optionally transmit an email notification (Block 166). Once the user account has been created, the user may create a user profile (Block 124).

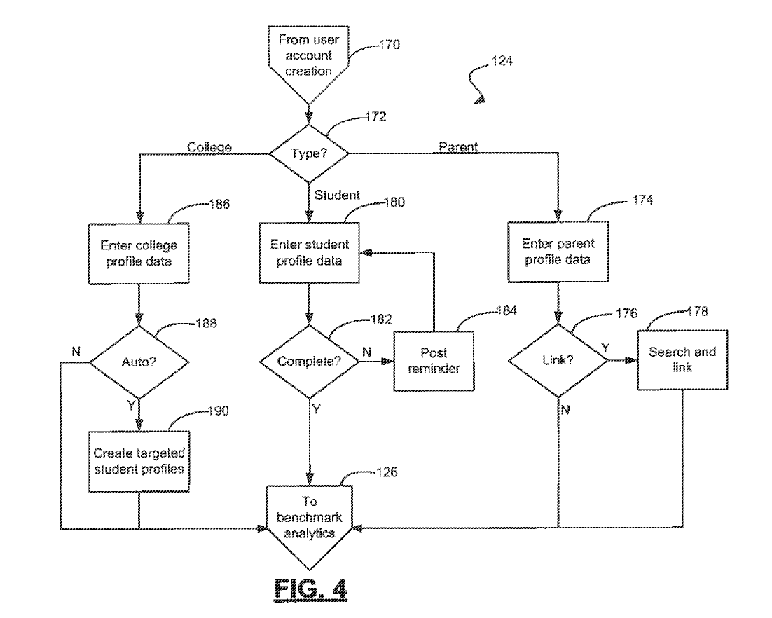

Referring now to flowchart 124 of FIG. 4, which expands the action described in Block 124 in FIG. 2, a computer implemented method of creating a user profile will now be discussed. The method of creating a user profile may include a series of steps, which may occur between a user operating a client device 50 and the decision support server 20. The following example may describe the user profile creation for three types of user profiles. A person of skill in the art will appreciate that the inclusion of three user profiles types has been selected for clarity and, in application, any number of user profile types may be created by the operations performed by the decision support system 10 in creating a user profile.

Starting at Block 170, the decision support system 10 may determine which type of user profile will be created (Block 172). If the user desires to create a parent user profile, the decision support system 10 of the present invention may prompt the user to enter parent profile data. The parent profile data may be stored in a database 28 as parameters. The system may also provide a form with predetermined sets of data for a parent user to complete (Block 174). The data may be stored in another profile table, which may be stored in the database 28, from which searches and analytics may be performed.

Parent users may choose whether to search for their children's student user accounts and link their parent account to their children's student accounts (Block 176). If the parent user chooses to link his or her user profile to a student user profile, the decision support system 10 of the present invention may search the database 28 for the student user account. The decision support system 10 may then link the student user profile to the parent profile (Block 178). After the parent user profile has been created, the decision support system 10 of the present invention may perform benchmarks and analytics (Block 126).

If the user desires to create a student user profile at Block 172, the decision support system 10 of the present invention may prompt the user to enter student profile data. The student profile data may be stored in a database 28 as parameters. The system may also provide a form with predetermined sets of data for a student user to complete (Block 180). The data is stored in another profile table, which may be stored in the database 28, from which searches and analytics may be performed.

The decision support system 10 of the present invention may review the parameters entered by the student user, along with additional profile data, on a periodic basis to determine if the student user profile is complete (Block 182). If a student user has not completed his or her student user profile creation, the decision support system 10 may post a reminder, or transmit a notification, to remind the user that this step needs to be completed (Block 184). The student user may then return to the operation of Block 180 and complete the entry of the student profile data. After the student user profile has been created, the decision support system 10 of the present invention may perform benchmarks and analytics (Block 126).

If the user desires to create a college or higher educational institution representative user profile at Block 186, the decision support system 10 of the present invention may prompt the user to enter college profile data. The college profile data may be stored in a database 28 as parameters. The system may also provide a form with predetermined sets of data for a college representative user to complete (Block 188). The data is stored in another profile table, which may be stored in the database 28, from which searches and analytics may be performed.

The decision support system 10 may provide automated system integration, which may be selected at Block 188. Through data-mapping and system integration, which may occur via web-technology, criteria of higher educational institution may be included in the decision support system 10 regarding desired student qualifications. The student profile qualification data may automatically be loaded into college and universities user profiles. If the college representative user selects to automatically generate the college represent user profile using the college admission criteria data, stored in the database 28, the college representative user profile may be generated. The decision support system 10 of the present invention may then perform benchmarks and analytics (Block 126).

The college representative user may desire to create a targeted student profile, or a profile with parameters that meet a criteria with different than an automatically generated college representative user profile, the decisions support system may prompt the user for entry of the aforementioned information (Block 190). The decision support system 10 of the present invention may then perform benchmarks and analytics (Block 126).

A student user may access a web interface or web portal that may include various academic and career support resources, tools and services for academic and career support. The resources may be available through active links in the portal. The portal may be hosted on a server computing device, such as the decision support server 20, and be accessible to a user by way of a client device 50. The creation of a user account may occur by manually completing forms, which may be in initiated by selecting a link, such as a “Create an Account”link. The “Create an Account” web page may include the web application 107 for collecting of user information embedded therein.

Once a user account is established and a user profile is built, a general or customized guide may be created for each user. The customized guide may be created through manual analysis or through automated analytical tools built into the web application 107. This guide may inform the user of his or her progress toward achieving educational goals. The guide may use information collected from peers, along key academic categories, and national benchmarks and other a data to determine the user's progress.

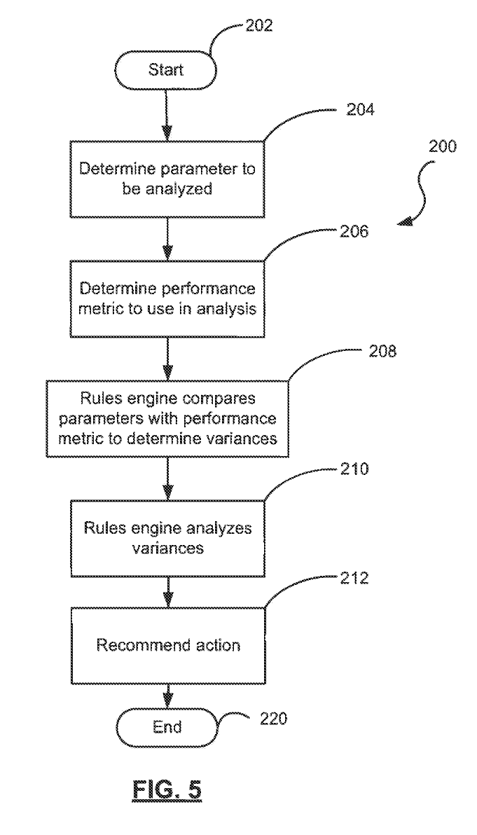

Referring now to FIGS. 5 and 8, which expand the data analysis action described in Block 126 in FIG. 2, a computer implemented method of performing data analysis on a student user profile will now be discussed. The method of performing data analysis may include a series of steps, which may occur between a user operating a client device 50 and the decision support server 20. The following example may describe the data analysis as it may pertain to a select user profiles. A person of skill in the art will appreciate that the select user profiles are described herein for clarity and, in application, any number of user profile types may be analyzed by the operations performed by the decision support system 10 in data analysis. A person of skill in the art will appreciate the inclusion of additional user profile types, such as, for example employer, private school, and agency, to be included within the scope and spirit of the present invention.

Referring now to FIG. 5, a flowchart 200 is shown that illustrates another computer implemented process that may be carried out by the decision support system 10 of FIG. 1A. The data analysis operation may start at Block 202 to analyze the parameters stored in the database 28 with performance metrics, via the rules engine 106. The data analysis operation may initially determine which parameter to be analyzed by the decision support system 10 of the present invention (Block 204). The data analysis operation may next determine the performance metric to use on the analysis of the parameter (Block 206). As discussed above, the performance metric may be included in a benchmark profile to define the desired academic performance of a student user.

The decision support system 10 may next apply the rules engine 106 to compare the parameters with the performance metrics and determine variances (Block 208). The rules engine 106 may then analyze the variances with the rules included therein (Block 210). After analysis of the variances has finished, the decisions support system of the present invention may recommend an action to the student user (Block 212). The data analysis may then terminate at Block 220. A person of skill in the art appreciate that the same steps may be performed by additional user profile types, such as, for example, a parent user profile.

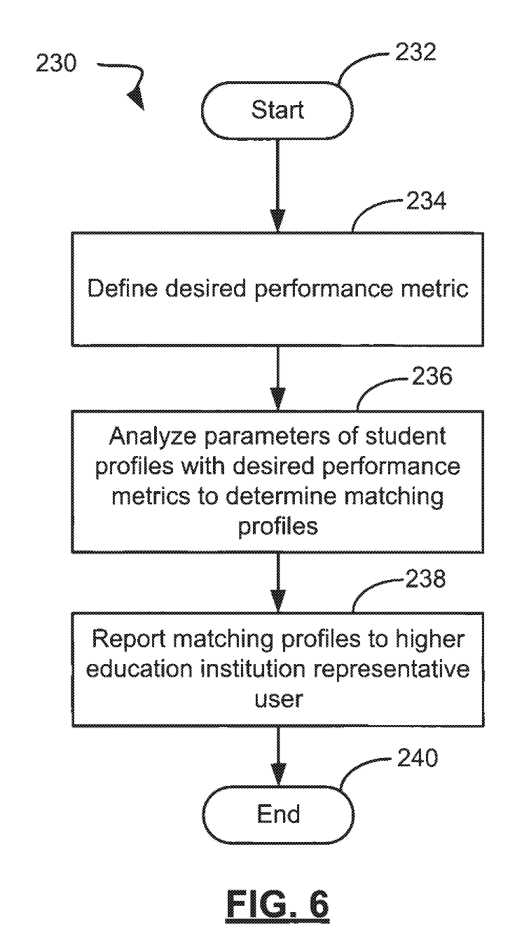

Referring now to FIG. 6, a chart 230 is shown that illustrates another computer implemented process that may be carried out by the decision support system 10 of FIG. 1A. The data analysis operation may start at Block 232 to analyze the parameters stored in the database 28 with performance metrics, via the rules engine 106. The data analysis operation may initially determine which parameter to be analyzed by the decision support system 10 of the present invention (Block 234). The data analysis operation may next determine the performance metric to use on the analysis of the parameter. As discussed above, the desired performance metric may be included in a target student profile, created by a higher educational institution representative user, to define the desired academic performance of a student user for potential enrollment in the higher educational institution.

The decision support system 10 may next apply the rules engine 106 to compare the parameters with the desired performance metrics to determine matches (Block 236). After determining which student user profiles are matches, the decision support system 10 of the present invention may report the matching student user profiles to the representative of the higher educational institution (Block 238). The data analysis may then terminate at Block 240.

The decision support system 10 of the present invention may also be expanded to service a variety of different types of organizations and their decision-making needs. Depending on the account type, the targeted profile data may be mined from the appropriate parameters. For example, a college representative user may have entered search parameters, or created a targeted student profile, seeking students in their junior year, with GPA's of 3.5 or higher and at least two extracurricular activities in which they've been involved for more than two years. The college representative user may also limit the search to include residents of the state in which the college operates.

The system may mine the profile data of the student profiles and push the matching student profiles to the user interface 108 of the college representative user. When college representatives user may log into the system, such as via an Internet connected client device 50, they may access the public data in the student profiles, review the profiles, and contact to the students directly via the web interface.

An additional computer implemented process that may be carried out by the decision support system 10 of the present invention, which is illustrated as Block 128 in FIG. 2 will now be discussed. An advisor management process may be included in the decision support system 10 of the present invention, which may be performed based on the stored user profile data. Users may also elect to have personal, one-on-one, advisement. Optionally, the decision support system 10 may require a fee for personal advisement. If the personal advisement is elected, the decision support system 10 may link the student user to an advisor user, which may have also established a user account. Similar to other users, the advisor may access his or her user account via a user interface 108, which may be accessed via a client device 50.

The advisor portfolio management process may begin by identifying each student user which may be paired with an advisor. A parameter or data element may be stored in each student profile. The decision support system 10 may review activity logs of each student user and determine whether a student user is actively engaging with the decision support system 10 and complying with the recommended actions. Activity level variances of a certain range may prompt a notification to be transmitted to the associated advisor user.

Advisor accounts may be stored in an advisor table. Activities may be defined for advisor users to complete and record through their user interface 108. The decision support server 20 may periodically review this activity and determine compliance of the same. For example, advisor users may be required to hold one-on-one advisement meetings with each of their students at set intervals, for example, at least twice a year. These advisement meetings would be logged in the decision support system 10 of the present invention. If a period has passed at which point the advisement meeting should have occurred, and there is no record of the meeting in the system, then a notification may be sent to the advisor reminding them to schedule and conduct the advisement meeting.

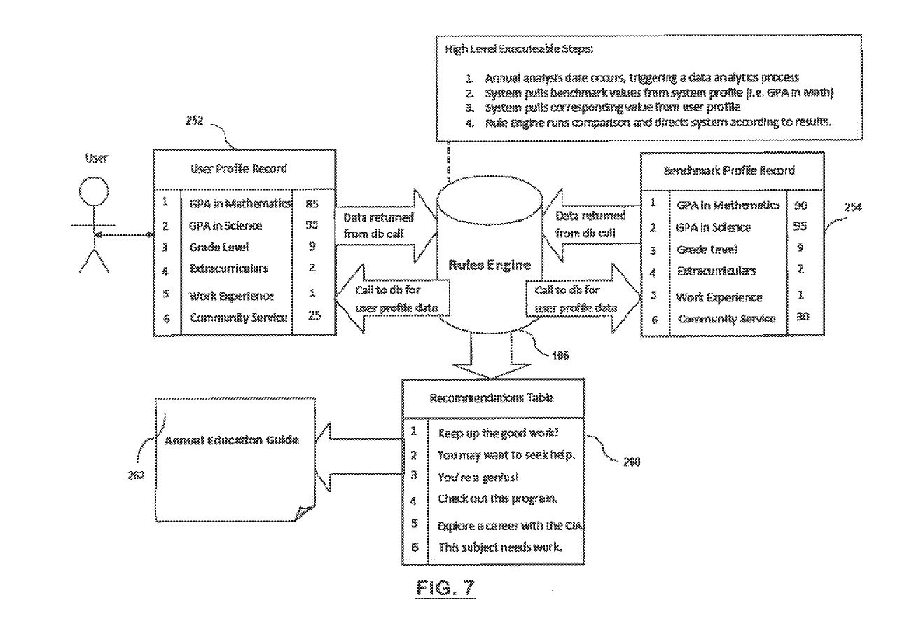

Referring now to FIG. 7, a block diagram illustrating data flow in accordance with the rules engine 106 included in decision support system 10 of the present invention will now be discussed. The illustrative decision support system 10 may be driven by data that has been input by a user as they may relate to informational fields. A user may input benchmark data into the decision support system 10. This user may be a student user, administrative user, or any other user.

The decision support system 10 may also allow for system driven inputs through integration with other systems, such as employer talent management systems, college admissions systems, or other third party database 28 that may include relevant information. In the example shown in FIG. 7, the user is a student who has created an account and completed their profile.

As shown, two records from tables 252, 254 within two separate relational database 28 tables are shown. The first record table 252 is a student record from a student user profile, which contains parameters. The parameters illustrated in FIG. 7 include, for example, the number of hours of community service the student user has performed, the GPA of the student user in Math and Science, the student grade level, and other parameters. A person of skill in the art will appreciate a plethora of additional parameters that may be included in the student user profile.

The second record table 254 is a benchmark profile. The benchmark profile may include a plurality of performance metrics related to educational goals. The benchmark profile may not be associated with an actual person, but may represent the recommended or target profile for a student at a particular educational level.

In the illustrative example, the rules engine 106 may generate an annual education guide for each student user. The rule engine 106 in this scenario may be triggered when a certain date has been reached. The decision support module 22 may access the database 28 that includes the user profile and extract the parameters included in the student user profile.

The decision support module 22 may then access the database 28 that includes the benchmark profile database and extract the performance metrics included in the benchmark profile. In the specific example illustrated in FIG. 9, the student user is in ninth grade, so the decision support system 10 would pull the performance metrics from the ninth grade benchmark profile. The decision support module 22 may then process rules to compare the two data sets.

Provided as a non-limiting example, the decision support module 22 may determine whether the student user's GPA in math was greater than or equal to the SPA in math of the benchmark profile. This determination may be made by comparing the parameters included in the student user profile with the performance metrics included in the benchmark profile to determine variances. The variances may then be analyzed to determine a recommended action to transmit to the student user.

The decision support module 22 may access the recommendations database 28 and pull the appropriate recommendation from the annual education guide recommendations table 260. The recommendation may be based on the analysis of the variances. In this example, the parameter for the student user's GPA in Math (85) is less than the recommended performance metric of 90 in the benchmark profile. Accordingly, the decision support may make a recommendation including text, such as, “Student A, you've shown tremendous diligence in your Math studies. You are very close to reaching your goal of a 90 GPA in Math. We recommend spending some time pin-pointing the content areas that are giving you the most difficulty and place some additional focus on those areas. There are a number of targeted tutorials, study guides, and practice tests that will help you improve in specific content areas. Keep up the great work!”

The system may take each recommendation pulled from the recommendations table, based on the data analysis conducted by the rules engine 106, and insert the recommendation into the annual education guide 262 template. A document may then be created and posted to the student's web portal. A person of skill in the art will appreciate that the document may be generated in any readable format, such as, but not limited to, PDF.

The rules processing example discussed with regard to FIG. 7 may be applied to numerous and varied data sets. The output of the rules logic could be in multiple forms, such as an email, a post to the portal, or an actual document such as the annual education guide. The data analysis could provide a report aggregating and analyzing academic performance of all students in the system. Alternately, the data analysis may be a more focused report, identifying and notifying a select set of students of their eligibility for selective scholarships.

A similar process as described above may be used for adult users in a non-educational embodiment of the decision support system 10 of the present invention. Based on information included in the user profile, appropriate resources may be identified from a resources server and be used to transmit recommendations to the user via a user interface 108. Career management assistance may be provided in much the same way as academic performance management assistance is provided to students.

For example, though the illustrative embodiment focuses on the parent account type, alternate embodiments may support a professional account type. Professional users may set up profiles that closely model resumes, which can be analyzed to provide recommendations obtained from a careers table to help professionals easily maintain their resumes and pinpoint career development gaps.

One such system analysis may reveal that a professional user has not updated their profile and/or resume within the last six months. This may indicate that the user's latest work experience is not documented. The system would send a notification to the user with a simple update form. The user may then complete the update form to update their user profile. At any point in a user's career, he or she may have an updated resume available.

Another analysis performed by the decision support server 20 of the present invention, as it may be defined within this embodiment, may reveal that the user does not have one or more certifications other may be held by other people competing for the same employment position. The decision support system 10 might recommend that the user consider acquiring an appropriate certification to build their marketability. The decision support system 10 may also provide information about the process of obtaining the certification.

The decision support system 10 of the present invention may include a feedback module to facilitate continuous feedback. In operation of the feedback module, surveys may be distributed to different user types within the system. For example, surveys may be sent to student users to provide feedback on the level of service their advisors are providing. The anonymous feedback may be quickly made available to advisors through their user interface 108, advantageously allowing the advisors to address any issues reported in the surveys proactively. In another embodiment of the present invention, feedback may be requested from the advisors and students on the system functionality.

The feedback information may be collected additionally via comment boxes, wherein an icon included in the user interface 108 may be included to initiate providing feedback. A form may then be presented to the users, wherein they may provide feedback. The feedback may optionally be delivered special email account for proactive review and action.

The guide may also recommend various tools, resources, and activities to accomplish educational goals. The tools and resources may be available through the web portal. The tools may be used by a user to improve key academic goal and begin exploring careers of interest. This evaluation process may happen periodically or dynamically. Access to the tools, resources, and activities may be facilitated through the web application 107 and interactive web portal. Students may continually build their profiles and develop a repository of key information and artifacts of interest to colleges and universities.

The decision support server 20 may also be configured to monitor the user's progress by periodically retrieving user profile parameters and comparing the user profile parameters to performance metrics included in a benchmark profile. Each time the decision support server 20 retrieves the user profile, it may identify the variances between the user's profile and the benchmark profile. The decision support system 10 may also select a recommended resource, action or series of actions based on the identified variances. The decision support server 20 may transmit the recommended resource, action or series of actions to the user, which may be accessed via a client device 50. The variances may be identified and subsequent recommendations made by use of a rules engine 106 having manually or automatically created rules for analyzing the parameters stored in the user's profile.

The decision support system 10 of the present invention may apply the data analysis and rules-driven architecture to provide demand forecasting services to schools. For example, the system may determine the amount of one-on-one tutoring needed at one school. The decision support system 10 may extrapolate this information to generate a tutoring demand forecast and project how many tutors are needed on staff. Building on the student scheduling example, the system can also aggregate the student data at a macro-level and forecast what the demand for various subjects may be based on a range of student driven data. This advantageously allows schools to be more proactive in their decision-making as opposed to reactive decision making, which may have negative effects to a student user's educational progress.

The system may also provide an expert exchange, an alternative means of online marketing for various service providers. Rather than simply offering service providers ad space on the web portal, the system may offer providers with a means of directly engaging with potential clients who are interested in the similar fashion as provided to colleges and universities. Provided as a non-limiting example, a person may be interested in purchasing a house and needs a realtor. Within their profile they select: interested in Real Estate Agent services and opt to have the system only recommend Real Estate Agents (one example of a service provider) in the system and/or allow Real Estate Agents to directly contact them. Service providers may also customize their own portals to host discussion forums, webinars, post tutorials, as a means of further engaging potential customers.

The system can integrate with (or replace) an employer's talent management system. Existing talent management systems don't allow companies to easily identify potential candidates—that is still something they have to actively do through their own devices. The contemplated decision support system 10 automates the identification of potential candidates (users in the system), connects them with potential employers and allows them to upload their data into the employers' talent management system and apply for a desired position, all with the click of a single button.

In yet another aspect, the contemplated decision support system 10 provides features related to automated artificial intelligence. The logic provided by the rules themselves may be automatically modified by the system in real-time based on the information and feedback provided by users of the system. As content, service providers and even specific recommendations produced by the system are rated, thresholds are defined such that if a reasonable number of users provided the same feedback within a certain period of time, the associated rules for the item being rated are modified.

For example, if the system recommended a particular service provider and that provider was consistently rated poorly by 10 users over the course of 2 months, the system would notify the service provider of this information, stipulating that their ranking was being altered and after the ranking of that provider so that when the rule fired again that particular service provider may not be recommended for the next 2 months. After 2 months, the rule may automatically revert back, with a notification to the service provider stating that the probationary period is ended and they are now being recommended again.

The system may also provide automated sales lead generation for an internal sales department. For example, as students are registering in the system, they are indicating their school and school district. Once a certain critical mass of students from within a certain school is reached, a sales lead report is generated, containing statistical analysis of the student information that can be used in a sales meeting with a school. This report is forwarded to the appropriate sales rep who can then engage a school's administration to discuss ways in which partnerships can be formed with the school. The same holds true for school districts, states, and federal entities.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. An educational decision support system comprising:
a decision support server that may include a memory to store a user profile defined by a set of parameters and a benchmark profile including a performance metric to be compared with the user profile, the decision support server including
a decision support server to compare at least one parameter from the set of parameters with the performance metric, and
a rules engine including rules to be used to compare the user profile and the benchmark profile,
wherein the rules engine determines variances between the at least one parameter and the performance metric, analyzes the variances, and recommends an action based on the variances;
a notification module that presents a notification based on the variances determined by the rules engine;
a collaboration module that compares a plurality of user profiles to determine educational goals that are substantially similar and that recommends a collaboration among the plurality of user profiles with the educational goals that are substantially similar;
a user profile creation module that prompts a user for the set of parameters to be used to generate the user profile;
a tiered operating structure including
a database tier including databases,
an application tier in communication with the database tier that may include a web application to control managing data within the databases, and
a presentation tier in communication with the application tier and the database tier that may include a user interface to allow the user to operate the web application from a client device;
wherein tools and resources are included on a resource server that is in communication with the decision support server via a network to support the user in making decisions relating to the educational goals;
wherein the web application is included on a web server that is in communication with the decision support server via the network to be accessed by the client device via the user interface,

2. A system according to claim 1 wherein the user profile is selected from a group consisting of a student profile, a parent profile to monitor the student profile, an advisor profile to monitor the student profile and select the action to be recommended by the decision support server regarding the student profile, a higher education institution representative profile to monitor the student profile, and an administrator profile to manage the plurality of user profiles.

3. A system according to claim 2 wherein the set of parameters may include private parameters and public parameters, wherein the public parameters are viewable by a higher educational institution, and wherein the private parameters are not viewable by the higher educational institution.

4. A system according to Claim I further comprising an admission application module on the decision support server to include admission applications accessed from the databases, wherein the admission application module populates fields included in the admission applications with the set of parameters included in the user profile.

5. A system according to Claim further comprising an application submission module on the decision support server to allow the user to select a higher educational institution and upload the at least one parameter to apply for enrollment to the higher educational institution.

6. A system according to Claim I further comprising a competition module on the decision support server that hosts academic competitions between the plurality of user profiles; wherein the user desirous of entering one of the academic competitions makes a submission using the competition module; wherein the competition module receives rating information from other users via the user interface directed to the submission; and wherein the competition module stores the rating information in the databases.

7. A system according to claim 6 wherein the competition module analyzes the rating information stored in the databases to determine the user profile with a highest rating based on the rating information stored in the database; and wherein the competition module transmits the notification to the user profile having the highest rating.

8. A system according to claim 1 wherein the collaboration module compares the plurality of user profiles to determine a group leader user profile to be included in the recommended collaboration between the plurality of user profiles.

9. A system according to claim 1 further comprising a guide module on the decision support server that may include a national benchmark profile on the database server including national averages, wherein the guide module compares the user profile and the national benchmark profile to determine the variances between the set of parameters and the national averages, analyze the variances, and recommend the action based on the variances.

10. A system according to claim 1 further comprising a financial literacy module on the decision support server, wherein the financial literacy module awards points for compliance with the action recommended by the decision support server.

11. A system according to claim 10 wherein the points are exchanged for rewards.

12. A system according to claim 1 further comprising an emergency notification module on the decision support server to monitor the user profile for undesired behavior, generate an emergency notification to an advisor indicating that the undesired behavior has occurred, and to generate a notification to indicate that the undesired behavior has occurred in the set of parameters included in the user profile.

13. A system according to claim 1 further comprising a validation module on the decision support server to verify that the set of parameters included in the user profile is accurate and in compliance with the rules prior to storing the set of parameters in the databases.

14. A method of using an educational decision support system to make a decision relating to educational goals, the educational support system comprising a decision support server that may include a memory to store a user profile defined by a set of parameters and a benchmark profile including a performance metric, the method comprising:
comparing the user profile with the performance metric;
using a decision support server of the decision support server to compare at least one parameter from the set of parameters with the performance metric;
comparing the user profile and the benchmark profile
determining variances between the at least one parameter and the performance metric;
analyzing the variances between the at least one parameter and the performance metric;
recommending an action based on the variances;
presenting a notification to a user based on the variances using a user interface;
comparing a plurality of user profiles to determine the educational goals that are substantially similar;
recommending a collaboration among the plurality of user profiles with the educational goals that are substantially similar;
prompting the user for the set of parameters to be used to generate the user profile;
wherein tools and resources are included on a resource server that is in communication with the decision support server via a network to support the user in making decisions relating to the educational goals;
wherein a web application is included on a web server that is in communication with the decision support server via the network to be accessed by the user interface.

15. A method according to claim 14 further comprising defining the user profile as one of a student profile, a parent profile to monitor the student profile, an advisor profile to monitor the student profile and select the action to be recommended by the decision support server regarding the student profile, a higher education institution representative profile to monitor the student profile, and an administrator profile to manage the plurality of user profiles.

16. A method according to claim 15 wherein the set of parameters may include private parameters and public parameters, wherein the public parameters are viewable by a higher educational institution, and wherein the private parameters are not viewable by the higher educational institution.

17. A method according to claim 14 further comprising populating fields included in admission applications with the set of parameters included in the user profile.

18. A method according to claim 14 further comprising using the decision support server to allow the user to select a higher educational institution and upload the at least one parameter to apply for enrollment to the higher educational institution.

19. A method according to claim 14 further comprising hosting an academic competition between the plurality of user profiles; wherein the user desirous of entering the academic competition makes a submission using a competition module of the decision support server; wherein the competition module receives rating information from other users via the user interface directed to the submission; and
wherein the competition module stores the rating information in the databases.

20. A method according to claim 19 wherein the competition module analyzes the rating information stored in the databases to determine the user profile with a highest rating based on the rating information stored in the database; and further comprising transmitting a notification to the user profile having the highest rating.

21. A method according to claim 14 further comprising comparing the plurality of user profiles to determine a group leader user profile to be included in the collaboration that is recommended between the plurality of user profiles.

22. A method according to claim 14 further comprising comparing the user profile and a national benchmark profile that may include national averages and is stored on the database server to determine variances between the set of parameters and the national averages; and further comprising analyzing the variances, and recommending the action based on the variances.

23. A method according to claim 14 further comprising awarding points for compliance with a financial literacy module on the decision support server, wherein the financial literacy module awards the points for compliance with the action recommended by the decision support server.

24. A method according to claim 23 wherein the points are exchanged for rewards.

25. A method according to claim 14 further comprising monitoring the user profile for undesired behavior, generating an emergency notification to an advisor indicating that the undesired behavior has occurred, and generating a notification to indicate that the undesired behavior has occurred in the set of parameters included in the user profile.

26. A method according to claim 14 further comprising verifying that the set of parameters included in the user profile is accurate and in compliance with the rules prior to storing the set of parameters in the databases.

27. A method of using an educational decision support system to make a decision relating to educational goals, the educational support system comprising a decision support server that may include a memory to store a user profile defined by a set of parameters and a benchmark profile including a performance metric, the method comprising:
comparing the user profile with the performance metric;
using a decision support server of the decision support server to compare at least one parameter from the set of parameters with the performance metric;
comparing the user profile and the benchmark profile
determining variances between the at least one parameter and the performance metric;
analyzing the variances between the at least one parameter and the performance metric;
recommending an action based on the variances;
presenting a notification to a user based on the variances using a user interface;
comparing a plurality of user profiles to determine the educational goals that are substantially similar;
recommending a collaboration among the plurality of user profiles with the educational goals that are substantially similar;
prompting the user for the set of parameters to be used to generate the user profile;
hosting an academic competition among the plurality of user profiles;
wherein the user desirous of entering the academic competition makes a submission using a competition module of the decision support server;
wherein the competition module receives rating information from other users via the user interface directed to the submission;
wherein the competition module stores the rating information in the databases;
wherein tools and resources are included on a resource server that is in communication with the decision support server via a network to support the user in making decisions relating to the educational goals;
wherein a web application is included on a web server that is in communication with the decision support server via the network to be accessed by the user interface;
wherein the user selects a higher educational institution and uploads the at least one parameter to apply for enrollment to the higher educational institution.

28. A method according to claim 27 further comprising defining the user profile as one of a student profile, a parent profile to monitor the student profile, an advisor profile to monitor the student profile and select the action to be recommended by the decision support server regarding the student profile, a higher education institution representative profile to monitor the student profile, and an administrator profile to manage the plurality of user profiles.

29. A method according to claim 28 wherein the set of parameters may include private parameters and public parameters, wherein the public parameters are viewable by a higher educational institution, and wherein the private parameters are not viewable by the higher educational institution.

30. A method according to claim 27 further comprising populating fields included in admission applications with the set of parameters included in the user profile.

31. A method according to claim 27 wherein the competition module analyzes the rating information stored in the databases to determine the user profile with a highest rating based on the rating information stored in the database; and further comprising transmitting a notification to the user profile having the highest rating.

32. A method according to claim 27 further comprising comparing the plurality of user profiles to determine a group leader user profile to be included in the collaboration that is recommended between the plurality of user profiles.

33. A method according to claim 27 further comprising comparing the user profile and a national benchmark profile that may include national averages and is stored on the database server to determine variances between the set of parameters and the national averages; and further comprising analyzing the variances, and recommending the action based on the variances.

34. A method according to claim 27 further comprising awarding points for compliance with a financial literacy module on the decision support server, wherein the financial literacy module awards the points for compliance with the action recommended by the decision support server.

35. A method according to claim 34 wherein the points are exchanged for rewards.

36. A method according to claim 27 further comprising monitoring the user profile for undesired behavior, generating an emergency notification to an advisor indicating that the undesired behavior has occurred, and generating a notification to indicate that the undesired behavior has occurred in the set of parameters included in the user profile.

37. A method according to claim 27 further comprising verifying that the set of parameters included in the user profile is accurate and in compliance with the rules prior to storing the set of parameters in the databases.
